(19) United States
(12) Patent Application Publication
(10) Pub. No.: US 2007/0021948 A1
(43) Pub. Date: Jan. 25, 2007

(54) Variable rate prescription generation using heterogenous prescription sources with learned weighting factors

(76) Inventor: Noel Wayne Anderson, Fargo, ND (US)

Correspondence Address: DEERE & COMPANY, ONE JOHN DEERE PLACE, MOLINE, IL, 61265, US

(21) Appl. No.: 11/186,334

(22) Filed: Jul. 21, 2005

(51) Int. Cl. G06F 17/10

(52) U.S. Cl. 703/2

(57) ABSTRACT

A method for prescribing a field operation by generating an optimized prescription with a weighted prescription subprocess, executing the field operation prescribed, and then updating the weighted prescription subprocess using a learning subprocess. The weighted prescription subprocess calculates and sums weighted output from two or more site-specific models to generate the optimized prescription. The learning subprocess determines new model weights as a function of relative model error calculated by comparing model output against actual and desired results of the executed field operation.

### FIELD OF THE INVENTION

The present invention relates to the practice of precision farming, and more specifically, to the generation of optimized field operation prescriptions.

### BACKGROUND OF THE INVENTION

Manual ground truthing of remotely sensed information has been a common practice for decades in many enterprises. Use of ground-truthed aerial information to generate site-specific application prescriptions has been practiced for over a decade in agricultural crop production. However, the impact of remotely sensed images has been limited in crop production because of the time and money required to do ground truthing of the image. What is needed in the art is a method of better utilizing remotely sensed images without frequent manual ground truthing.

### SUMMARY OF THE INVENTION

This invention improves the usefulness of remote images by learning site-specific rate weighting factors for a given field over time. This invention shows how prescriptions from heterogeneous sources, including aerial images, can be improved over time using a site-specific weighting system that learns based on past performance. Automated crop data collection combined with crop models and learned correction factors may also be used to improve the effectiveness of site-specific crop management and reduce its cost.

### BRIEF DESCRIPTION OF THE DRAWINGS

FIG. 1 illustrates a method for prescribing a variable-rate field operation employing two or more models and a learning subprocess.

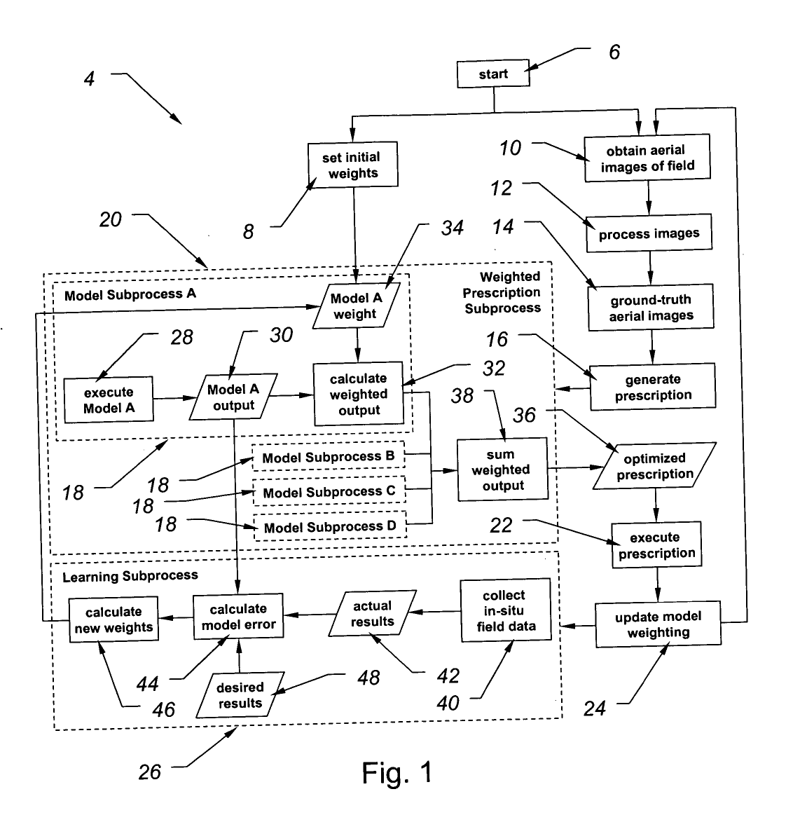

### DETAILED DESCRIPTION

This invention description focuses on variable rate application of the chemical PIX to cotton. One skilled in the art will see how the invention applies to variable rate application of other chemicals (pesticides, fungicides, fertilizers, etc) to other crops, as well as for other field operations such as tillage, seeding, and harvesting. This invention shows how prescriptions from heterogeneous sources, including aerial images, can be improved over time using a site-specific weighting system that learns based on past performance. Automated crop data collection combined with crop models and learned correction factors may also be used to improve the effectiveness of site-specific crop management and reduce its cost.

The general prescription method 4 for each contemplated field operation/chemical application is as follows: Step 1: obtain aerial images 10 of a crop in a desired field. These may be obtained from just above the crop using a ground based device, aircraft, or satellites, and may be timed by crop and weather prediction models. Step 2: perform standard processing 12 of the aerial images. This includes, but is not limited to, geo-rectification, patching, reflectance correction, color correction, cloud corrections, etc. The company GeoVantage currently provides this service on a commercial basis. Step 3 (optionally): perform ground truthing activity 14 for the aerial images. Step 4: generate an optimized variable rate chemical application prescription 16 based on aerial field images and other data with two or more model subprocesses 18 per a weighted prescription subprocess 20. Step 5: execute the prescribed variable rate operation over the field 22. Step 6: update site-specific model weightings 24 based on in-situ crop information, such as height in the case of cotton, per a learning subprocess 26. Step 7: repeat the prescription method 4 for each field operation by starting at step one 10.

Embodiments for the weighted prescription subprocess 20 and the learning subprocess 26 are illustrated below. Machine learning is a diverse and growing field, so other embodiments will be apparent to one skilled in the art. For example, the algorithm described for the weighted prescription subprocess 20 could be replaced with one based on neural networks, particle filters, Kalman filters, etc. The present embodiment uses rasters as a means of representing aggregated site-specific data, but polygons, quadtrees and other representations are also useable.

The general method for the weighted prescription subprocess 20 is as follows: Step A1: for each model subprocess 18, execute a given model 28 to generate output 30, a field sub-area element (raster, polygon, etc), with a recommended application rate or other field operation parameter. Models 28 could include, but are not limited to aerial images, in situ field data, one or more crop models, soil moisture models, and soil productivity indices. Step A2: for each element of model output 30, calculate a weighted output 32 based on model weights 34 assigned for each model 28. The sum of the weights 34 for all models 28 used should equal 1.0 or 100%. Thus, for example, an element may give 50% weight to the prescription based on recent aerial images, 25% to a prescription based on a first crop model, 12.5% based on a second crop model, and 12.5% weight to a prescription based on a governmental soil productivity index. The first time this process is used, a weight of 1.0 may be given to a specific source such as a recent aerial image. Alternately, all prescription models 28 could be given equal weighting. Step A3: generate an optimized field operation prescription value 36 for each field sub-area by summing the weighted output 38 from all model subprocesses 18 employed.

The general method for the learning subprocess 26 is as follows: Step B1: at some time after the field operation 22, in-situ crop information is collected 40 for actual results 42 on how the prescription method 4 performed. In the case of variable rate PIX application, the post-process data would include plant height and/or height variability changes. For each field node in the prescription grid, the amount was either correct, low, or high by some amount. Step B2: an estimated “correct” amount to get desired results 48 is calculated for each field node element and compared with the output 30 from each model 28 to determine model error 44. Step B3: from the determination of model error 44, new weights 34 are calculated 46 for each model 28. Models 28 having output 30 closer to the correct value have their weights 34 increased, those further away have their weights 34 decreased. In general, the updated formula for the (x,y) element of the weighting matrix of the ith source is:
Weight(i,x,y)=k*f (prescription error (i,x,y))+(1−k)*g(past weight(s) (i,x,y))

Where k is for weighting current and past performance in coming up with a new weight. The function g may actually consider more than just the most recent weight. In that regard, the new weight can be thought of as a filtered value. An example of re-weighting is provided below and is not necessarily the best scheme: four prescription models with equal weighting of 0.25 provide prescriptions of 3.50, 3.65, 4.00, and 4.25 for a given field raster element. The weighted prescription is
(3.50*0.25)+(3.65*0.25)+(4.00*0.25)+(4.25*0.25)=3.85

After observing the actual results 42 of the chemical application 22, it is estimated that the rate should have been 3.95. For example, the applied PIX rate did not inhibit cotton growth as much as desired and a higher rate should have been used. The four prescription sources have errors of magnitude 0.45, 0.30, 0.05, and 0.30 and magnitude percentages of 11.4%, 7.6%, 1.2%, and 7.6% with an average of 6.95%. Function f (prescription error (i,x,y)) will multiply the base weights by the average error / source error and then renormalize (=>indicates “dividing by 2.06=0.15+0.23+1.45+0.23” to renormalize):
0.25*(6.95%/11.4%)=0.15=>0.073
0.25*(6.95%/7.60%)=0.23=>0.121
0.25*(6.95%/1.20%)=1.45=>0.725
0.25*(6.95%/7.60%)=0.23=>0.121

Next in this example, a value of k=0.3 (and 1−k=0.7) is selected to demonstrate a preference for past weightings over most recent weightings in adjusting the weights 34 to be used next time:
=k *f( )+(1−k)*g( )
0.190=0.3*0.073+0.7*0.25
0.205=0.3*0.121+0.7*0.25
0.400=0.3*0.725+0.7*0.25
0.205=0.3*0.121+0.7*0.25

As mentioned earlier, other learning algorithms and reweighing schemes may be used here, including but not limited to neural networks and particle filters. Having described the preferred embodiment, it will become apparent that various modifications can be made without departing from the scope of the invention as defined in the accompanying claims.

1. A method for prescribing a field operation comprising steps of:
generating an optimized field operation prescription by executing a weighted prescription subprocess having steps of:
executing two or more site-specific models each generating model output for a field operation prescription;
calculating a weighted model output for each model based on a corresponding model weight; and
summing the weighted model output for each model to generate the optimized field operation prescription;
executing a field operation instructed by the optimized prescription; and
updating the model weights for each model used in the weighted prescription subprocess by executing a learning subprocess having steps of:
collecting in-situ crop data for actual results of the field operation;
calculating model error by comparing model output with actual results and desired results; and
calculating new model weights as a function of relative model error.

2. The method described in claim 1 wherein the field operation is a chemical application, a tillage operation, seeding operation, or a harvest operation.

3. The method described in claim 1 wherein the field operation is a variable rate chemical application to a crop.

4. A method for prescribing a field operation comprising steps of:
obtaining aerial images of a crop;
performing standard processing of the aerial images;
generating an optimized field operation prescription by executing a weighted prescription subprocess having steps of:
executing two or more site-specific models each generating model output for a field operation prescription;
calculating a weighted model output for each model based on a corresponding model weight; and
summing the weighted model output for each model to generate the optimized field operation prescription;
executing a field operation instructed by the optimized prescription; and
updating the model weights for each model used in the weighted prescription subprocess by executing a learning subprocess having steps of:
collecting in-situ crop data for actual results of the field operation;
calculating model error by comparing model output with actual results and desired results; and
calculating new model weights as a function of relative model error.

5. The method described in claim 4 wherein the field operation is a chemical application, a tillage operation, seeding operation, or a harvest operation.

6. The method described in claim 4 wherein the field operation is a variable rate chemical application to a crop.

7. The method described in claim 4 wherein the field operation is a variable rate application of PIX to cotton.
